(19) United States
(12) Patent Application Publication
(10) Pub. No.: US 2003/0009395 A1
(43) Pub. Date: Jan. 9, 2003

(54) Method and apparatus for providing information regarding a product

(76) Inventors: Philip Shi-Lung Yu, Chappaqua, NY (US); David P. Greene, Ossining, NY (US); Edith H. Stern, Yorktown Heights, NY (US); Barry E. Willner, Briarcliff Manor, NY (US)

Correspondence Address: BUCKLEY, MASCHOFF, TALWALKAR, & ALLISON, 5 ELM STREET, NEW CANAAN, CT, 06840, US

(21) Appl. No.: 09/900,543

(22) Filed: Jul. 6, 2001

(51) Int. Cl. G06F 17/60

(52) U.S. Cl. 705/27

(57) ABSTRACT

A system, method, apparatus, and computer program code for providing and receiving information regarding a product. According to embodiments of the present invention, a location (e.g., a Web site, database) is established or determined wherein information regarding a product or a person can be found. Access to some or all of the information may be limited or provided only to specific people or devices. The information may be information regarding a product and an address associated with the location may be provided to a recipient of the product, a provider of the provider, etc. The receiver of the address can use the address to access the information or pass the address along to others. The information may be updated by or based on the recipient, the provider, or another party or device. In some embodiments, the address may be printed directly on packaging associated with a product.

### FIELD OF THE INVENTION

The present invention relates to a method and apparatus for providing information regarding a product and, more particularly, embodiments of the present invention relate to methods, apparatus, and computer program code for providing and receiving information for a drug or prescription product.

### BACKGROUND OF THE INVENTION

In many health or medical care systems, access to information regarding drugs and medications, medical treatments, etc. may be difficult for people to obtain. Moreover, a person taking a drug may want to know certain information about the drug. For example, the person may want to know what dosage of the drug is usually recommended, what side effects does the drug has, etc. More specifically, the person may want to know how he or she will react to the drug or may want to obtain information tailored to the person's specific situation. For example, the person may want to know how drug treats the person's medical specific condition, what side effects the person might expect given the person's medical condition, or what interactions may occur as a result of other drugs the person is taking, etc.

In other situations, a person may want to grant access to his or her health or medical information to a doctor, therapist, pharmacy, etc. The person may want to grant access to certain portions of the information to certain people or devices and/or for a limited amount of time.

It would be advantageous to provide a method and apparatus that facilitates providing and/or receiving information about a product, particularly a drug or other product available via prescription, and allowed a person to access and/or provide specific information about the drug or other product and/or the person.

### SUMMARY OF THE INVENTION

Embodiments of the present invention provide a system, method, apparatus, and computer program code for providing and receiving information regarding a product. Embodiments of the invention are particularly well suited for providing or receiving information regarding one or more drugs or other products available via prescription. According to embodiments of the present invention, a location (e.g., a Web site, database) is established or determined wherein information regarding a product or a person can be found. In some embodiments of the present invention, access to some or all of the information may be limited or provided only to specific people or devices. In some embodiments, the information may be information regarding a product and an address associated with the location may be provided to a recipient of the product, a provider of the product, etc. The receiver of the address can use the address to access the information or pass the address along to others. The information may be updated by or based on the recipient, the provider, or another party or device. In some embodiments, the address may be printed directly on packaging associated with a product. For example, the address may be or include a telephone number or World Wide Web (“Web”) site address or URL (Uniform Resource Locator) pointing or linking to the Web site.

Additional objects, advantages, and novel features of the invention shall be set forth in part in the description that follows, and in part will become apparent to those skilled in the art upon examination of the following or may be learned by the practice of the invention.

According to embodiments of the present invention, a method for providing information regarding a product includes determining an address for a location where information regarding a product is available; providing data indicative of the address to an entity that can provide the product; receiving information regarding a recipient of the product; and revising or otherwise updating the information regarding the product based, at least in part, on the information regarding a recipient. In another embodiment of the present invention, a method for providing information regarding a product includes determining an address for a location, wherein information regarding a product available via a prescription can be found at the location without additional routing; receiving a prescription to provide the product to a recipient; creating packaging for the product that includes the address; and providing the product with the packaging. In a further embodiment of the present invention, a method for providing information regarding a product includes determining an address for a location, wherein information regarding a product can be found at the location without additional routing; and providing data indicative of the address to an entity that can provide the product. In yet another embodiment of the present invention, a method for providing information regarding a product includes establishing a location for information regarding a person; allowing the person to partition access to the information; receiving a request to provide access to a portion of the information to a party; and providing access to the portion of the information by the party if such access is authorized.

According to one embodiment of the present invention, a system for providing information regarding a product includes a memory; a communication port; and a processor connected to the memory and the communication port, the processor being operative to determine an address for a location where information regarding a product is available; provide data indicative of the address to an entity that can provide the product; receive information regarding a recipient of the product; and update or otherwise revise the information regarding the product based, at least in part, on the information regarding a recipient. In another embodiment of the present invention, the process may instead be operative to determine an address for a location, wherein information regarding a product available via a prescription can be found at the location without additional routing; receive a prescription to provide the product to a recipient; creating packaging for the product that includes the address; and provide the product with the packaging. In a further embodiment of the present invention, the processor may instead be operative to determine an address for a location, wherein information regarding a product can be found at the location without additional routing; and provide data indicative of the address to an entity that can provide the product. In yet another embodiment of the present invention, the process may instead be operative to establish a location for information regarding a person; allow the person to partition access to the information; receive a request to provide access to a portion of the information to a party; and provide access to the portion of the information by the party if such access is authorized.

According to one embodiment of the present invention, an apparatus for providing information regarding a product includes means for identifying an address for a location where information regarding a product is available; means for sending data indicative of the address to an entity that can provide the product; means for obtaining information regarding a recipient of the product; and means for altering the information regarding the product based, at least in part, on the information regarding a recipient. In another embodiment of the present invention, an apparatus for providing information regarding a product includes means for identifying an address for a location, wherein information regarding a product available via a prescription can be found at the location without additional routing; means for obtaining a prescription to provide the product to a recipient; and means for establishing packaging for the product that includes the address. In a further embodiment of the present invention, an apparatus for providing information regarding a product includes means for identifying an address for a location, wherein information regarding a product can be found at the location without additional routing; and means for sending data indicative of the address to an entity that can provide the product. In yet another embodiment of the present invention, an apparatus for providing information regarding a product includes means for identifying a location for information regarding a person; means for partitioning access to the information; means for obtaining a request to provide access to a portion of the information to a party; and means for sending access to the portion of the information by the party if such access is authorized.

According to one embodiment of the present invention, a computer program product in a computer readable medium for providing information regarding a product includes first instructions for identifying an address for a location where information regarding a product is available; second instructions for sending a notification indicative of the address to an entity that can provide the product; third instructions for obtaining information regarding a recipient of the product; and fourth instructions for revising the information regarding the product based, at least in part, on the information regarding a recipient. In another embodiment, a computer program product in a computer readable medium for providing information regarding a product includes first instructions for identifying an address for a location, wherein information regarding a product available via a prescription can be found at the location without additional routing; second instructions for obtaining a prescription to provide the product to a recipient; and third instructions for establishing packaging for the product that includes the address. In a further embodiment, a computer program product in a computer readable medium for providing information regarding a product includes first instructions for identifying an address for a location, wherein information regarding a product can be found at the location without additional routing; and second instructions for sending data indicative of the address to an entity that can provide the product. In another embodiment, a computer program product in a computer readable medium for providing information regarding a product includes first instructions for identifying a location for information regarding a person; means for partitioning access to the information; second instructions for obtaining a request to provide access to a portion of the information to a party; and third instructions for sending access to the portion of the information by the party if such access is authorized.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a flowchart of a first embodiment of a method in accordance with the present invention;

FIG. 2 is a flowchart of a second embodiment of a method in accordance with the present invention;

FIG. 3 is a flowchart of a third embodiment of a method in accordance with the present invention;

FIG. 4 is a flowchart of a fourth embodiment of a method in accordance with the present invention;

FIG. 5 is a block diagram of system components for an embodiment of an apparatus usable with the methods of FIGS. 1-4;

FIG. 6 is a block diagram of components for a representative server of FIG. 5;

FIG. 7 is an illustration of a representative user information database of FIG. 6;

FIG. 8 is an illustration of a representative user device information database of FIG. 6;

FIG. 9 is an illustration of a representative entity database of FIG. 6; and

FIG. 10 is an illustration of a representative product information database of FIG. 6.

### DETAILED DESCRIPTION

Applicants have recognized that there is a need for systems and methods that allow a person to access, receive and/or provide information regarding a product the person may be using of the person himself or herself. In addition, applicants have recognized that there is a need to provide systems and methods for allowing a person to control or limit access to such information. These and other features will be discussed in further detail below, by describing a system, individual devices, and processes according to embodiments of the invention. In one example implementation of the present invention, a World Wide Web (“Web”) site may be established that includes information specific to a product (e.g., a drug) and/or a person. The address (e.g., Uniform Resource Locator or link) to the Web site may be provided to the person. The person may use the address to access the Web site and the information stored on the Web site. The information may be tailored to the specific person. That is, the information on the Web site regarding the drug may include information regarding use of the drug by the specific person. In another example, the address may be provided on packaging with the drug. Thus, a pharmacy may include the address on packaging for the drug when the pharmacy provides the drug to an individual.

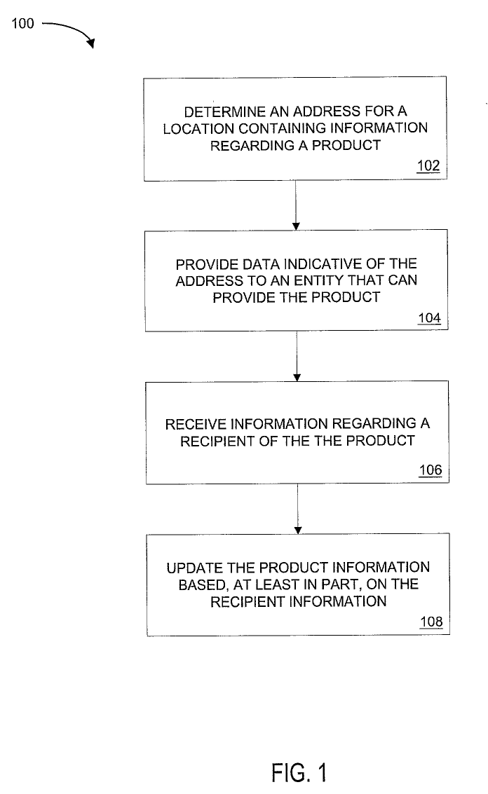

Process Description Reference is now made to FIG. 1, where a flow chart 100 is shown which represents the operation of a first embodiment of the present invention. The particular arrangement of elements in the flow chart 100 is not meant to imply a fixed order to the steps; embodiments of the present invention can be practiced in any order that is practicable. In some embodiments, some or all of the steps of the method 100 may be performed or completed by a server, user device and/or another device, as will be discussed in more detail below.

Processing begins at a step 102 during which an address for a location containing information, or where the information is otherwise available, regarding a product is determined. An address may be or include a telephone number, a URL, hyperlink, Web site address or domain name, or other electronic or computer address or identifier. In some embodiments, the product may be a drug or be available only via prescription, exemption, rule or other dispensation.

A location may be or include a Web site (which may have one or more Web pages), a database, a telephone call center, an automated voice response system, etc. In some embodiments, a location may be or include a link or call to where additional information regarding the product is located, can be found or retrieved, etc.

The information regarding the product may be or include a picture of the product, information regarding product use, history, side effects, or safety, etc. In some embodiments wherein the product is a drug or prescription product, the information may be or include a picture of the product, information regarding use, side effects, dosage amounts, history, etc. of the product, information regarding alternatives to the product, information regarding interaction of the product with another drug or medication, information regarding a user's history of use of the drug or other medical information, a code or other identifier for the product, the user's treatment history, etc.

In some embodiments, determining an address where for a location where information regarding a product is available may include associating a URL, telephone number or other address with the location, receiving a notification or other data indicative of the address and/or the location, selecting the address from among a plurality of available addresses, determining, hosting or establishing a Web site at which the information can be found, determining, establishing or identifying a database at which the information can be found, etc.

In some embodiments, any request, command, or other communication, data or notification described herein that may be sent or received during any step of any method described herein, may be in any form or format, including, but not limited to, a HTTP (Hypertext Transfer Protocol), HTML (Hypertext Mark-up Language) or FTP (File Transfer Protocol) transmission, XML (Extensible Mark-up Language) feed, email message, instant message communication, facsimile or radio transmission, telephone call, electronic signal or communication, etc.

During a step 104, data indicative of the address determined during the step 102 is provided to an entity that can provide the product. In some embodiments, the entity may be a supplier, manufacturer, distributor, reseller, shipper, deliverer, etc. of the product. If the product is a drug or other prescription product, the entity may be a pharmacy or doctor's office. Providing data indicative of the address may include sending an electronic notification or other communication to the entity, allowing the entity to retrieve or download the information from a Web site, database or other source, etc.

In some embodiments, the entity receiving the data sent during the step 104 may include some or all of the information on packaging associated with the product. For example, the entity may include information on a label or container of the product or in promotional materials or instructions provided with the product.

During a step 106, information is received regarding a recipient of the product. The information may be received directly or indirectly from the recipient, the entity involved in the step 104, or some other party or device. For example, if the entity is a pharmacy and the product is a drug or other prescription product, the pharmacy may provide information regarding a recipient of the drug or prescription product from the pharmacy.

In some embodiments, the step 106 may be completed prior to or during the step 104. The step 106 may be or include receiving an electronic communication from the recipient or the entity, the electronic communication including some or all of the information regarding a recipient of the product; receiving an electronic communication from a service provider associated with the recipient, the electronic communication including some or all of the information regarding a recipient of the product; receiving an electronic communication from a provider of the product, the electronic communication including some or all of the information regarding a recipient of the product; receiving an electronic communication, that includes data indicative of a location of the information regarding a recipient of the product.

During a step 108, information regarding a product is altered or otherwise updated based, at least in part, on the information received during the step 106. The step 108 or the method 100 may include receiving information regarding the product or use of the product from the recipient, a service provider, an entity or another party or device and updating the information regarding the product accordingly; updating the information regarding the product the, at least in part, on at least one demographic (e.g., age, gender, race, occupation, income level, educational experience, nationality) characteristic of the recipient; updating the information regarding the product based, at least in part, on a medical condition, health or other characteristic of the recipient, etc. For example, if the product is a drug and once a particular recipient of the product is known, the information may be revised or otherwise updated based on the recipient. More specifically, the product information on dosage, use, treatment options, etc. may be changed or amended to be more tailored, applicable or useful to the particular recipient.

In some embodiments, the method 100 may include setting-up, arranging, coordinating or otherwise establishing a location or address for information regarding a product, entity, recipient, product provider, etc. Information regarding one or more recipients might be stored in, or accessed from, a recipient or user database. Information regarding one or more products might be stored in, or accessed from, a product database. Information regarding one or more product providers might be stored in, or accessed from, a product or product provider database. Information regarding one or more entities might be stored in, or accessed from, an entity database.

In some embodiments of the method 100, each of a group of recipients may receive a unique address to a location containing information regarding a product. For example, each recipient may receive a unique URL or other electronic address to a Web site or other location where information regarding a product can be located.

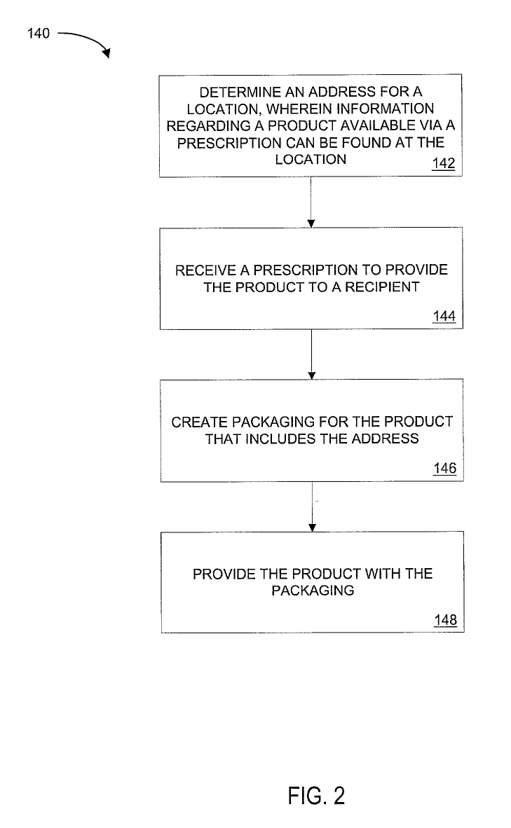

Reference is now made to FIG. 2, where a flow chart 140 is shown which represents the operation of a second embodiment of the present invention. The particular arrangement of elements in the flow chart 140 is not meant to imply a fixed order to the steps; embodiments of the present invention can be practiced in any order that is practicable. In some embodiments, some or all of the steps of the method 140 may be performed or completed by a server, user device and/or another device, as will be discussed in more detail below. The method 140 is particularly well suited for implementation by or on behalf of a pharmacy, drug or grocery store, etc. that may sell, distribute or otherwise provide drugs or other prescription products.

Processing begins at a step 142 during which an address for a location containing information, or where the information is otherwise available, regarding a product available via an order, request, instruction, command, prescription, etc. (hereinafter referred to as a “prescription”) is determined. An address may be or include a telephone number, a URL, hyperlink, Web site address or domain name, or other electronic or computer address or identifier. The method 142 is similar to the step 102 previously discussed above.

A location may be or include a Web site (which may have one or more Web pages), a database, a telephone call center, an automated voice response system, etc. In some embodiments, a location may be or include a link to where additional information regarding the product is located, can be found or retrieved, etc.

The information regarding the product may be or include a picture of the product, information regarding use, side effects, dosage amounts, history, etc. of the product, information regarding interaction of the product with another drug or medication, information regarding a user's history of use of the drug or other medical information, a code or other identifier for the product, etc.

In some embodiments, determining an address where for a location where information regarding a product is available may include associating a URL, telephone number or other address with the location, receiving a notification or other data indicative of the address and/or the location, selecting the address from among a plurality of available addresses, determining a Web site at which the information can be found, determining a database at which the information can be found, receiving a notification that includes the address or information regarding the address from a provider of the product, etc.

During a step 144, an order, request, instruction, command, prescription, etc. (hereinafter referred to as a “prescription”) to provide the product is received. The prescription may be received in printed or electronic form and may come directly or indirectly from a service provider (e.g., a doctor), a recipient of the product, or another party. Thus, in some embodiments, the step 144 may be or include receiving the prescription in print format or electronic format, receiving data indicative of the prescription and/or the product, receiving the prescription from a service provider, the recipient, a provider of the product, etc., receiving the prescription from a party on behalf of the recipient, etc.

During a step 146, packaging is created that includes the address determined for the product during the step 142. In some embodiments, the step 146 may be initiated and/or completed prior to the step 144. In some embodiments, creating packaging for the product that includes the address may include one or more of the following: providing a label on a container of the product, wherein the label includes some or all of the address; providing some or all of the address on a container of the product; providing some or all of the address on usage (e.g., instructions), promotional or other materials associated with the product; receiving the packaging from another party (e.g., a supplier, distributor, or manufacturer of the product); allowing a recipient of the product or another party to select the packaging; etc.

During a step 148, the product is provided along with the packaging. The product may be provided directly or indirectly to a recipient. For example, en entity implementing the method 140 or the step 148 may sell or distribute the product with the packaging; provide the product and packaging to the recipient or other party via mail, delivery, in-store pick-up, etc.

In some embodiments, the method 140 may include variations previously discussed above in regard to the method 100. For example, in some embodiments, the method 140 may include setting-up, arranging, coordinating or otherwise establishing a location or address for information regarding a product, entity, recipient, product provider, etc. as previously discussed above.

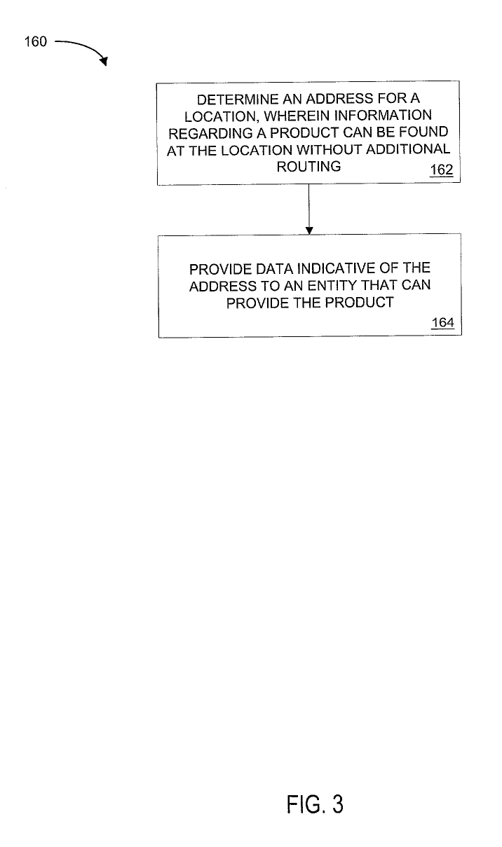

Reference is now made to FIG. 3, where a flow chart 160 is shown which represents the operation of a third embodiment of the present invention. The particular arrangement of elements in the flow chart 160 is not meant to imply a fixed order to the steps; embodiments of the present invention can be practiced in any order that is practicable. In some embodiments, some or all of the steps of the method 160 may be performed or completed by a server, user device and/or another device, as will be discussed in more detail below. The method 160 is particularly well suited for implementation by or on behalf of a supplier of a product (e.g., a drug manufacturer) or a service provider (e.g., a doctor).

Processing begins at a step 162 during which an address is determined for a location containing information for a product, or where the information is otherwise available for a product, without additional routing. An address may be or include a telephone number, a URL, hyperlink, Web site address or domain name, or other electronic or computer address or identifier. The method 162 is similar to the step 102 previously discussed above. In some embodiments, the product may be a drug or other product available only via prescription.

In the method 160, the information is available at the location without further routing. Thus, a person accessing the location does not need to do any further navigation or contact any additional location to access at least some information regarding the product. For example, the address determined during the step 162 may include a URL for a Web page. At least some information regarding the product is available at the specific Web page without requiring the person to navigate to another Web page. As another example, the address determined during the step 162 may include a telephone number and code that gives access to information regarding the product.

As with the methods previously discussed above, a location may be or include a Web site (which may have one or more Web pages), a database, a telephone call center, an automated voice response system, etc. In some embodiments, a location may be or include a link to where additional information regarding the product is located, can be found or retrieved, etc.

The information regarding the product may be or include a picture of the product, information regarding use, side effects, dosage amounts, history, etc. of the product, information regarding interaction of the product with another drug or medication, information regarding a user's history of use of the drug or other medical information, a code or other identifier for the product, etc.

During a step 164, data indicative of the address is provided to an entity (e.g., a supplier, distributor, seller) that can provide the product to a recipient. For example, in some embodiments the product may be a drug and, during the step 164, information regarding the drug is provided via email, instant message communication, facsimile, etc. to one or more drug stores that sell or will sell the drug.

The method 160 may include variations previously discussed above in regard to the method 100 and/or the method 140. In some embodiments, the method 160 may include receiving information regarding a recipient of the product from the recipient, from a service provider associated with the recipient, or a provider of the product; receiving information from a party regarding the product; receiving information regarding use of the product from a recipient of the product, etc. In addition, in some embodiments, the method 160 may include updating the information regarding the product available at the location based, at least in part, on information received from a recipient of the product or some other party.

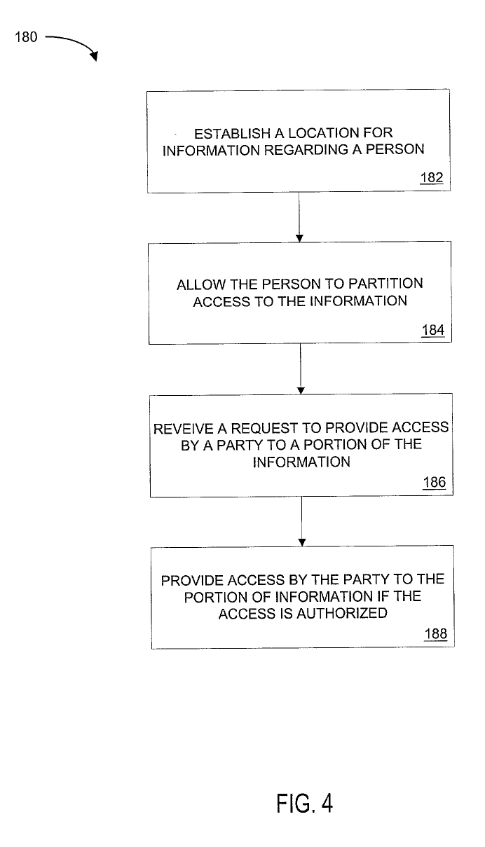

Reference is now made to FIG. 4, where a flow chart 180 is shown which represents the operation of a fourth embodiment of the present invention. The particular arrangement of elements in the flow chart 180 is not meant to imply a fixed order to the steps; embodiments of the present invention can be practiced in any order that is practicable. In some embodiments, some or all of the steps of the method 180 may be performed or completed by a server, user device and/or another device, as will be discussed in more detail below. The method 180 is particularly well suited for implementation by a party or device on behalf of or under the control of another person.

Processing begins at a step 182 during which a location is established for storage of information regarding a person. In some embodiments, a location may be or include a Web site (which may have one or more Web pages), a database, a telephone call center, an automated voice response system, etc. In some embodiments, a location may be or include a link to where additional information regarding the product is located, can be found or retrieved, etc. The step 182 may be or include establishing a Web page that includes the information; determining a link to a Web page that includes the information; establishing a database that includes the information; establishing a telephone number or voice response system with which the information can be retrieved; etc.

The information regarding a person may be or include information regarding the person's age, gender, race, nationality, occupation, height, weight, family history, medical history, medical records, treatment history, etc. Thus, the information may be or include any information related to the person. The information also may include information regarding one or more service providers the person is using or may use. For example, the information may include information on doctors' hours, costs, office directions, background and qualifications, etc.

During a step 184, the person involved in the step 182, or another device or entity on the person's behalf, under the person's control, or with the person's permission, is allowed to partition access to the information. For example, a person may want to let members of his or her family or his or her doctors have access to all of the information but not let any one else have access to any of the information. Alternatively, the person may want certain doctors to have access only to certain information. As another example, the person may want a pharmacy to be able to access all information regarding the person's medications but not any other medical information. As a further example, the person may want to limit some people to only reading some or all of the information while other people may have the right to update, delete, add to, etc. the information. Thus, allowing a person to partition information may be or include allowing the person to grant an ability to at least one other person to access the information; allowing the person to grant an ability to at least one other person to read the information; allowing the person to grant an ability to at least one other person to update the information; allowing the person to grant an ability to at least one other person to add new information, etc.

Partitioning access may involve the person associating addresses to some or all of the information with people who have access to the information, associating passwords to the people and/or the information granted access by the passwords, etc.

In some embodiments, the person may grant access to some or all of the information for a limited or fixed period of time or grant only a limited or fixed number of accesses to some or all of the information. For example, a doctor may be granted access to some or all of the information only for the time period prior to and following a visit by the person. Alternatively, or in conjunction, the doctor may be granted access to some or all of the information a maximum of four times.

In some embodiments, the step 184 may be or include allowing the person to control access to some or all of the information; allowing the person to allow access by another party to a portion of the information during a time period established by the person; allowing the person to allow assess to a portion of the information by a service provider (e.g., a doctor, pharmacy, therapist); allowing the person to allow access to a first portion of the information by a first server provider and a second portion of the information by a second server provider; allowing the person to allow access to a first portion of the information by a first server provider and a second portion of the information by a second server provider, wherein the first server provider does not have access to the second portion of information and the second service provider does not have access to the first portion of information; allowing the person to provide access to at least two distinct portions of the information to a respective at least two other parties.

In some embodiments, access to different portions of the information may be protected by password or other security measure. Different portions of the information may have different addresses associated with them. For example, a person's medical information stored on a Web site may be accessed via a first URL and a first password and the person's family information may be stored on the Web site via a different URL and a second password. Navigation from one part of the Web site to another part of the Web site might be restricted without the proper URL and/or password.

During a step 186, a request or other communication is received regarding access to a portion of the information. The request may be received from a party wanting access or from a recipient or device on behalf of such party. In some embodiments, the request may be received via email message or other electronic communication. The request may include a description of the information sought or for which the requester has access.

In some embodiments, if the information is protected by password or other security measure, the request may include the password; a code, name or other identifier associated with the person or entity requesting access to the information; a code, name or other identifier associated with the information for which access is being requested; a code, name or other identifier associated with the person; the address for the information; etc. In some embodiments, a system or device implementing the method 180 or the step 186 may request the password, address, description of the information, etc. In some embodiments, one password may be needed to access the location of the information and another password may be needed to access the information itself. The request received during the step 186 may include one or both of these passwords.

During a step 188, access to some or all of the information is provided to the party making the request so long as such access is allowed or otherwise authorized. The step 188 may be or include allowing the party to retrieve, update, browse, download, etc. some or all of the information; allowing the party to update the portion of information; sending some or all of the information to the party; determining or verifying that access to the information is authorized; etc. The method 180 also may include a step of determining or verifying that a party is authorized to access some or all of a person's information, providing a notification to the person when access is to some or all of the information is granted or requested, etc.

In some embodiments, the method 180 may include variations previously discussed above in regard to the methods 100, 140 and 160.

System

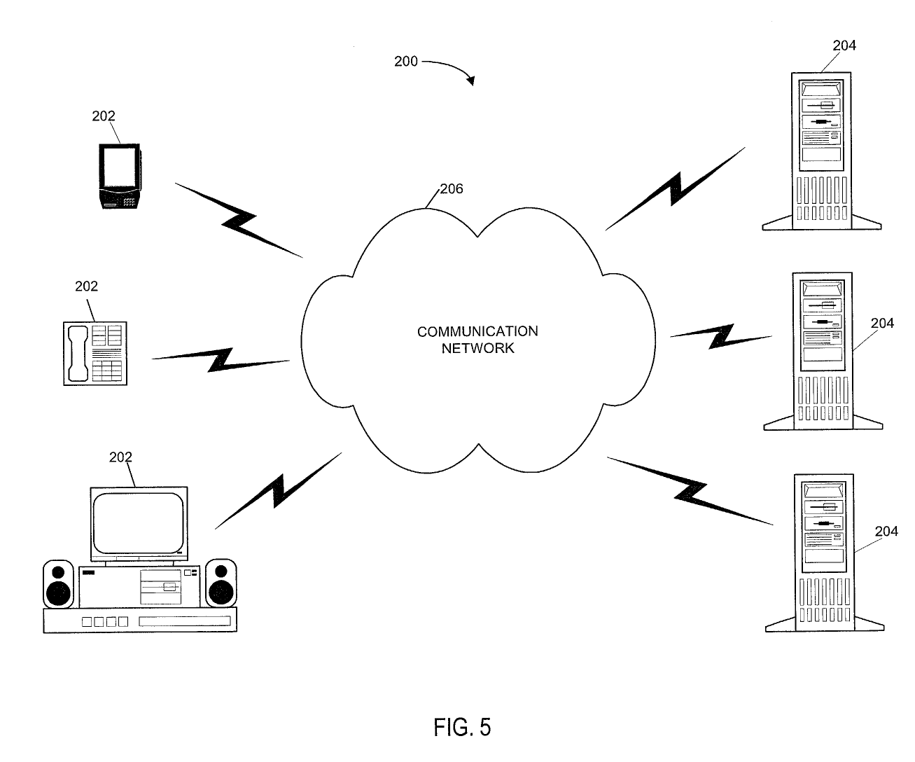

Now referring to FIG. 5, an apparatus or system 200 usable with the methods disclosed herein is illustrated. The apparatus 200 includes one or more user or client devices 202 that may communicate directly or indirectly with one or more servers, controllers or other devices 204 via a computer, data, data or communications network 206.

In some embodiments, a server 204 may implement or host a Web site. A server 204 can comprise a single device or computer, a networked set or group of devices or computers, a workstation, etc. In some embodiments, a server 204 also may function as a database server and/or as a user device. The use, configuration and operation of servers will be discussed in more detail below.

The user or client devices 202 preferably allow users or other parties to interact with the server 204 and the remainder of the apparatus 200. The user devices 202 also may enable a user to access Web sites, software, databases, etc. hosted or operated by the servers 204. If desired, the user devices 202 also may be connected to or otherwise in communication with other devices. Possible user devices include a personal computer, portable computer, mobile or fixed user station, workstation, network terminal or server, cellular telephone, kiosk, dumb terminal, personal digital assistant, etc. In some embodiments, information regarding one or more users and/or one or more user devices may be stored in, or accessed from, a user information database and/or a user device information database.

Many different types of implementations or hardware configurations can be used in the system 200 and with the methods disclosed herein and the methods disclosed herein are not limited to any specific hardware configuration for the system 200 or any of its components.

The communications network 206 might be or include the Internet, the World Wide Web, or some other public or private computer, cable, telephone, client/server, peer-to-peer, or communications network or intranet, as will be described in further detail below. The communications network 206 illustrated in FIG. 5 is meant only to be generally representative of cable, computer, telephone, peer-to-peer or other communication networks for purposes of elaboration and explanation of the present invention and other devices, networks, etc. may be connected to the communications network 206 without departing from the scope of the present invention. The communications network 206 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a server 204 without departing from the scope of the present invention. Moreover, as used herein, communications include those enabled by wired or wireless technology.

In some embodiments, a suitable wireless communication network 206 may include the use of Bluetooth technology, allowing a wide range of computing and telecommunication devices to be interconnected via wireless connections. Specifications and other information regarding Bluetooth technology are available at the Bluetooth Internet site www.bluetooth.com. In embodiments utilizing Bluetooth technology, some or all of the devices of FIG. 5 may be equipped with a microchip transceiver that transmits and receives in a previously unused frequency band of 2.45 GHz that is available globally (with some variation of bandwidth in different countries). Connections can be point-to-point or multipoint over a current maximum range of ten (10) meters. Embodiments using Bluetooth technology may require the additional use of one or more receiving stations to receive and forward data from individual user devices 202 or servers 204.

Although three user devices 202 and three servers 204 are shown in FIG. 5, any number of such devices may be included in the system 200. The devices shown in FIG. 5 need not be in constant communication. For example, a user device may communicate with a server only when such communication is appropriate or necessary.

Server

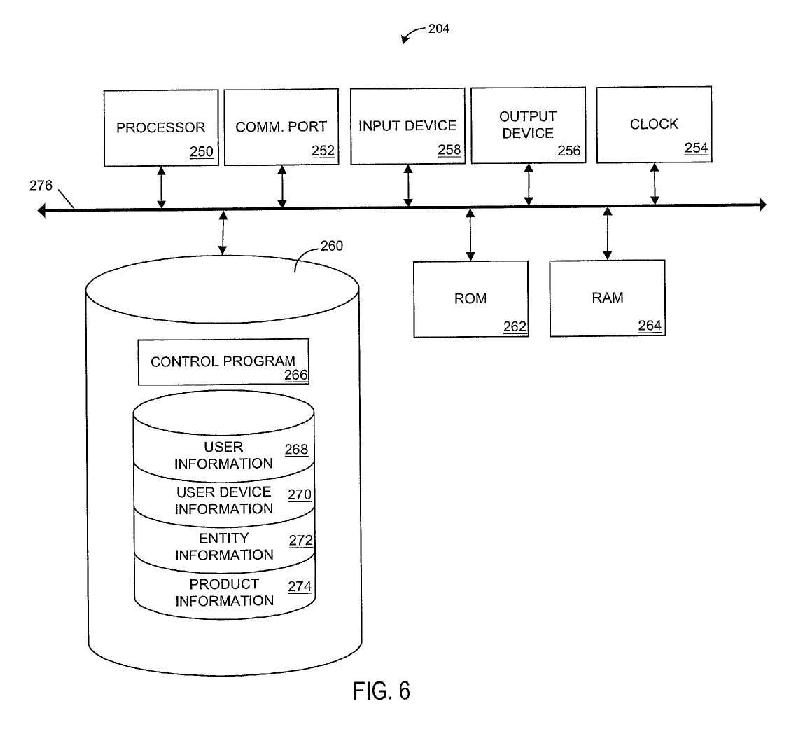

Now referring to FIG. 6, a representative block diagram of a server or controller 204 is illustrated. The server 204 may include a processor, microchip, central processing unit, or computer 250 that is in communication with or otherwise uses or includes one or more communication ports 252 for communicating with user devices and/or other devices. Communication ports may include such things as local area network adapters, wireless communication devices, Bluetooth technology, etc. The server 204 also may include an internal clock element 254 to maintain an accurate time and date for the server 204, create time stamps for communications received or sent by the server 204, etc.

If desired, the server 204 may include one or more output devices 256 such as a printer, infrared or other transmitter, antenna, audio speaker, display screen or monitor, text to speech converter, etc., as well as one or more input devices 258 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 204 may include a memory or data storage device 260 to store information, software, databases, communications, device drivers, etc. The memory or data storage device 260 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The server 204 also may include separate ROM 262 and/or RAM 264.

The processor 250 and the data storage device 260 in the server 204 each may be, for example: (i) located entirely within a single computer or other computing device; or (ii) connected to each other by a remote communication medium, such as a serial port cable, telephone line or radio frequency transceiver. In one embodiment, the server 204 may comprise one or more computers that are connected to a remote server computer for maintaining databases.

A conventional personal computer or workstation with sufficient memory and processing capability may be used as the server 204. In one embodiment, the server 204 operates as or includes a Web server for an Internet environment. The server 204 preferably is capable of high volume transaction processing, performing a significant number of mathematical calculations in processing communications and database searches. A Pentium™ microprocessor such as the Pentium III™ microprocessor, manufactured by Intel Corporation may be used for the processor 250. Equivalent processors are available from Motorola, Inc., AMD, or Sun Microsystems, Inc. The processor 250 also may comprise one or more microprocessors, computers, computer systems, etc.

Software may be resident and operating or operational on the server 204. The software may be stored on the data storage device 260 and may include a control program 266 for operating the server, databases, etc. The control program 266 may control the processor 250. The processor 250 preferably performs instructions of the control program 266, and thereby operates in accordance with the present invention, and particularly in accordance with the methods described in detail herein. The control program 266 may be stored in a compressed, uncompiled and/or encrypted format. The control program 266 furthermore includes program elements that may be necessary, such as an operating system, a database management system and device drivers for allowing the processor 250 to interface with peripheral devices, databases, etc. Appropriate program elements are known to those skilled in the art, and need not be described in detail herein.

The server 204 also may include or store information regarding users, communications, products, user devices, product providers, communication channels, etc. For example, information regarding one or more users may be stored in or access from a user information database 268 for use by the server 204 or another device or entity. Information regarding one or more user devices may be stored in or access from a user device information database 270 for use by the server 204 or another device or entity. Information regarding one or more entities may be stored in or access from an entity information database 272 for use by the server 204 or another device or entity. Information regarding one or more products may be stored in or access from a product information database 274 for use by the server 204 or another device or entity. In some embodiments, one or more of the databases may be stored or located remotely from the server 204.

According to an embodiment of the present invention, the instructions of the control program may be read into a main memory from another computer-readable medium, such as from the ROM 262 to the RAM 264. Execution of sequences of the instructions in the control program causes the processor 250 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 250, communication port 252, clock 254, output device 256, input device 258, data storage device 260, ROM 262, and RAM 264 may communicate or be connected directly or indirectly in a variety of ways. For example, the processor 250, communication port 252, clock 254, output device 256, input device 258, data storage device 260, ROM 262, and RAM 264 may be connected via a bus 276.

While specific implementations and hardware configurations for servers 204 have been illustrated, it should be noted that other implementations and hardware configurations are possible and that no specific implementation or hardware configuration is needed. Thus, not all of the components illustrated in FIG. 6 may be needed for a server implementing the methods disclosed herein. Therefore, many different types of implementations or hardware configurations can be used in the system 200 and the methods disclosed herein are not limited to any specific hardware configuration.

User Device

As mentioned above, user device 202 may be or include any of a number of different types of devices, including, but not limited to a personal computer, portable computer, mobile or fixed user station, workstation, network terminal or server, telephone, beeper, kiosk, dumb terminal, personal digital assistant, facsimile machine, two-way pager, radio, cable set-top box, etc. If desired, the user device 202 also may function as a server 204 and/or as another type of device. In some embodiments, a user device 202 may have the same structure or configuration as the server 204 illustrated in FIG. 6 and include some or all of the components of the server 204.

Databases

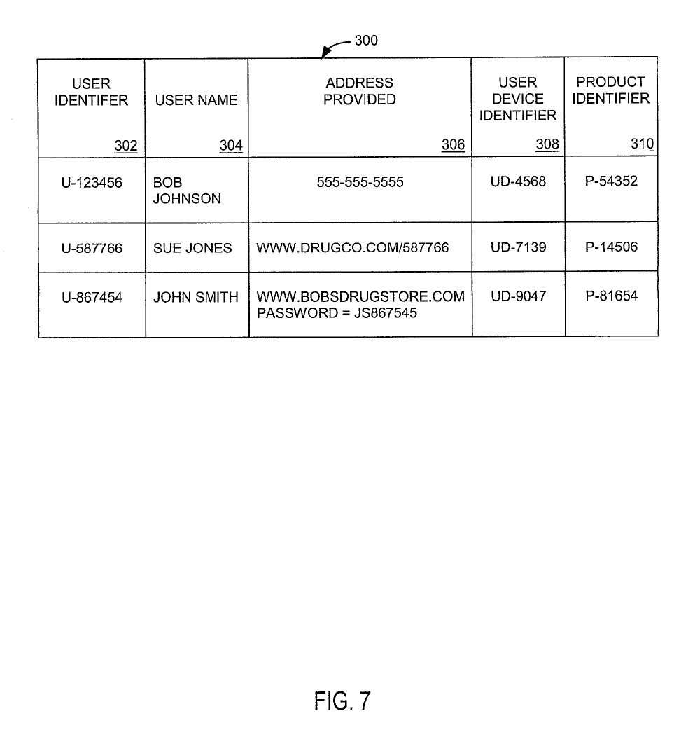

As previously discussed above, in some embodiments a server, user device, or other device may include or access a user information database for storing or keeping information regarding one or more users. One representative user information database 300 is illustrated in FIG. 7.

The user information database 300 may include a user identifier field 302 that may include codes or other identifiers for or associated with one or more users, a user name field 304 that may include a name or other descriptive information for the users identified in the field 302, an address field 306 that may include electronic or other addresses, telephone numbers, email addresses, URL's or other contact information provided to or associated with the users identified in the field 302, a user device identifier field 308 that may include one or more identifiers of user devices associated with the users identified in the field 302, and a product identifier field 310 that my include one or more identifiers or other information for one or more products associated with the users identified in the field 302. Other or different fields also may be used in the user information database 300.

As illustrated by the user information database of FIG. 7, the user identified as “U-123456” in the field 302 is named “BOB JOHNSON”. The address or telephone number “555-555-5555” has been provided to the user identified as “U-123456”. In addition, the user identified as “U-123456” is associated with user device “UD-4568” and product “P-54352.” Information regarding the user device “UD-4568” might be found in a user device information database while information regarding the product “P-54352” might be found in a product information database. In some embodiments, a user might be associated with more than one user device and/or more than one product. Similarly a product and/or a user device might be associated with more than one user.

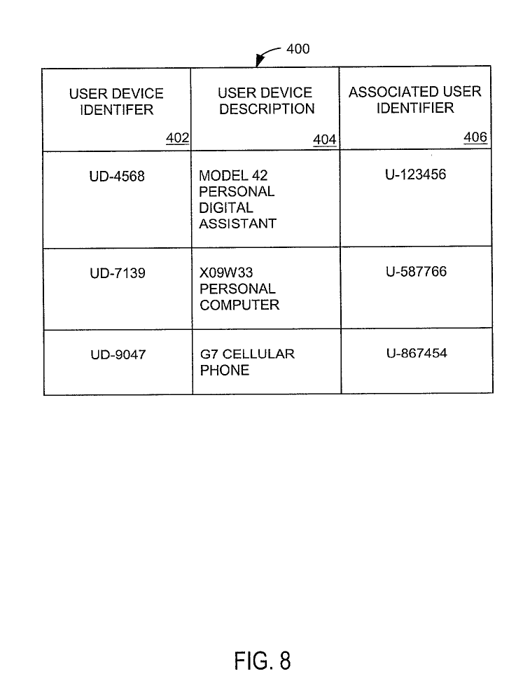

As previously discussed above, in some embodiments a server, user device, or other device may include or access a user device information database for storing or keeping information regarding one or more user devices. One representative user device information database 400 is illustrated in FIG. 8.

The user device database 400 may include a user device identifier field 402 that may include codes or other identifiers for or associated with one or more user devices, a user device name or description field 404 that may include a name or other descriptive information for the user devices identified in the field 402, and a user identifier field 406 that may include one or more identifiers or other information for one or more users associated with the user devices identified in the field 402. Other or different fields also may be used in the user device information database 400. As illustrated in the user device information database 400 of FIG. 8, the user device identified as “UD-4568” in the field 402 is a “MODEL 42 PERSONAL DIGITAL ASSISTANT” and is associated with the user identified as “U-123456.”

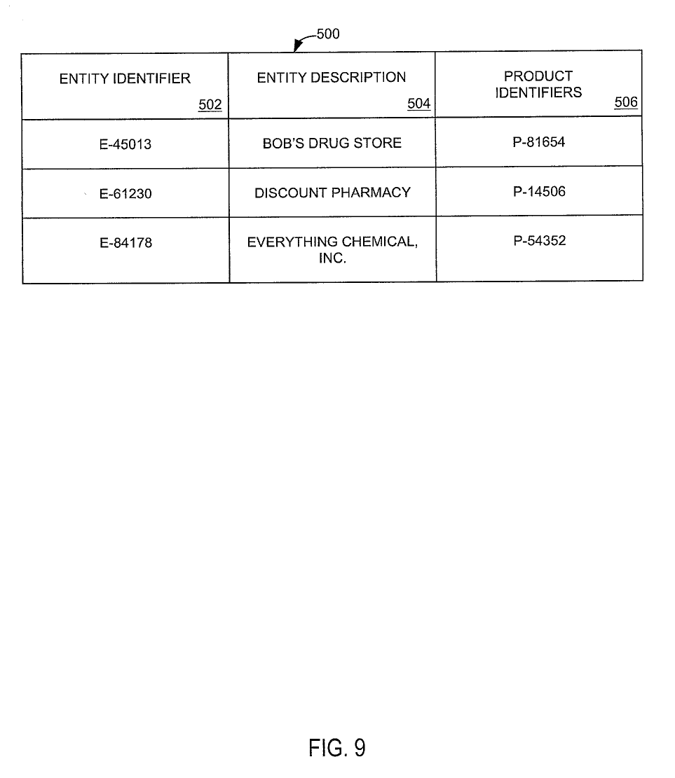

As previously discussed above, in some embodiments a server, user device, or other device may include or access an entity database for storing or keeping information regarding one or more entities. One representative entity database 500 is illustrated in FIG. 9.

The entity database 500 may include an entity identifier field 502 that may include codes or other identifiers for or associated with one or more entities, an entity name or description field 504 that may include a name or other descriptive information for the entities identified in the field 502, and a product identifier field 506 that may include one or more identifiers or other information for one or more products associated with the entities identified in the field 502. Other or different fields also may be used in the entity information database 500. As illustrated in the entity information database 500 of FIG. 9, the entity identified as “E-45013” in the field 502 is “BOB'S DRUG STORE” and is associated with the product identified as “P-81654.” In some embodiments, an entity may be associated with more than one product, and vice-versa. Information regarding the product “P-81654” might be found in a product information database.

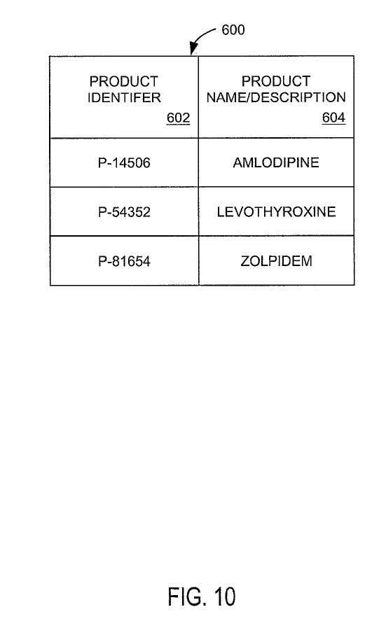

As previously discussed above, in some embodiments a server, user device, or other device may include or access a product information database for storing or keeping information regarding one or more products. One representative product information database 600 is illustrated in FIG. 10.

The product information database 600 may include a product identifier field 602 that may include codes or other identifiers for or associated with one or more products and a product name or description field 604 that may include name or other information for the products identified in the field 602. Other or different fields also may be used in the product information database 600. As illustrated by the product information database 600 of FIG. 10, the product identified as “P-14506” in the field 602 is “AMLODIPONE” while the product identified as “P-54352” in the field 602 is “LEVOTHYROXINE.”

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to a preferred embodiment thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for providing information regarding a product, comprising:
determining an address for a location where information regarding a product is available;
providing data indicative of said address to an entity that can provide said product;
receiving information regarding a recipient of said product; and
updating said information regarding said product based, at least in part, on said information regarding a recipient.

2. The method of claim 1, wherein said determining an address for a location where information regarding a product is available includes at least one of the following:
associating a URL with said location;
determining a link to said information;
associating a telephone number with said location;
determining a World Wide Web site at which the information can be found;
determining a database at which the information can be found;
receiving data indicative of said address and said location; and
selecting said address from among a plurality of available addresses.

3. The method of claim 1, wherein said providing data indicative of said address to an entity that can provide said product includes at least one of the following:
sending an electronic communication including said data to said entity; and
allowing said entity to retrieve said data.

4. The method of claim 1, wherein said receiving information regarding a recipient of said product includes at least one of the following:
receiving an electronic communication from said recipient, said electronic communication including at least a portion of said information regarding a recipient of said product;
receiving an electronic communication from a service provider associated with said recipient, said electronic communication including at least a portion of said information regarding a recipient of said product;
receiving an electronic communication from said entity, said electronic communication including at least a portion of said information regarding a recipient of said product;
receiving an electronic communication from a provider of said product, said electronic communication including at least a portion of said information regarding a recipient of said product; and
receiving an electronic communication, said electronic communication including data indicative of a location of said information regarding a recipient of said product.

5. The method of claim 1, wherein said updating said information regarding said product based, at least in part, on said information regarding a recipient includes at least one of the following:
receiving information regarding use of said product from said recipient and updating said information regarding said product accordingly;
updating said information regarding said product based, at least in part, on at least one demographic characteristic of said recipient; and
updating said information regarding said product based, at least in part, on a medical condition of said recipient.

6. The method of claim 1, wherein each of a plurality of recipients of said product can receive a unique address to a location where information regarding said product is available.

7. The method of claim 1, wherein said entity can include said address on packaging associated with said product.

8. The method of claim 1, wherein said product is available via prescription.

9. The method of claim 1, wherein said product is a drug.

10. The method of claim 1, wherein said location includes at least one of the following:
a call center;
a Web page; and
a database.

11. The method of claim 1, wherein said address includes at least one of the following:
a telephone number; and
a URL.

12. The method of claim 1, wherein said information includes at least one of the following:
a picture of said product;
product history information;
information regarding use of said product; and
information regarding potential affects of said recipient's use of said product.

13. The method of claim 1, wherein said product is a drug and said information includes at least one of the following:
a picture of said product;
information regarding use of said product;
information regarding potential side effects of said product;
information regarding dosage amounts of said product;
product history information;
information regarding interaction of said product with another drug; and
information regarding said recipient's history of use of said drug.

14. The method of claim 1, further comprising at least one of the following:
receiving information regarding said recipient from a service provider associated with said recipient;
receiving information from a party regarding said product; and
receiving information regarding use of said product from said recipient.

15. The method of claim 1, further comprising:
establishing said location.

16. A method for providing information regarding a product, comprising:
determining an address for a location, wherein information regarding a product available via a prescription can be found at said location without additional routing;
receiving a prescription to provide said product to a recipient;
creating packaging for said product that includes said address; and
providing said product with said packaging.

17. The method claim 16, wherein said determining an address for a location, wherein information regarding a product available via a prescription can be found at said location without additional routing includes at least one of the following:
receiving said address from a provider of said product;
associating a URL with said location;
associating a telephone number with said location;
receiving data indicative of said address and said location; and
selecting said address from among a plurality of available addresses.

18. The method claim 16, wherein said receiving a prescription to provide said product to a recipient includes at least one of the following:
receiving said prescription in print format;
receiving said prescription in electronic format;
receiving data indicative of said prescription;
receiving said prescription from said recipient; and
receiving said prescription from a party on behalf of said recipient.

19. The method claim 16, wherein said creating packaging for said product that includes said address includes at least one of the following:
providing a label on a container of said product, said label including said address; and
providing said address on a container of said product.

20. The method claim 16, wherein said providing said product with said packaging includes at least one of the following:
selling said product in said packaging;
distributing said product in said packaging; and
providing said product and said packaging to said recipient.

21. The method of claim 16, further comprising:
establishing said location.

22. A method for providing information regarding a product, comprising:
determining an address for a location, wherein information regarding a product can be found at said location without additional routing; and
providing data indicative of said address to an entity that can provide said product.

23. The method claim 22, further comprising at least one of the following:
receiving information regarding said recipient from a service provider associated with said recipient;
receiving information from a party regarding said product; and
receiving information regarding use of said product from said recipient.

24. The method claim 22, wherein said product is available by prescription.

25. The method claim 22, further comprising:
receiving information regarding a recipient of said product; and.

26. The method claim 25, further comprising:
updating said information regarding said product based, at least in part, on said recipient.

27. A method for providing information regarding a product, comprising:
establishing a location for information regarding a person;
allowing said person to partition access to said information;
receiving a request to provide access to a portion of said information to a party; and
providing access to said portion of said information by said party if such access is authorized.

28. The method of claim 27, wherein said establishing a location for information regarding a person includes at least one of the following:
establishing a Web page that includes said information;
determining a link to a Web page that includes said information;
establishing a secure database that includes said information; and
establishing a telephone number with which said information can be retrieved.

29. The method of claim 27, wherein said allowing said person to partition access to said information includes at least one of the following:
allowing said person to control access to all of said information;
allowing said person to allow access by another party to a portion of said information during a time period established by said person;
allowing said person to allow access to a portion of said information by a service provider;
allowing said person to allow access to a first portion of said information by a first server provider and a second portion of said information by a second server provider;
allowing said person to allow access to a first portion of said information by a first server provider and a second portion of said information by a second server provider, wherein said first server provider does not have access to said second portion of information and said second service provider does not have access to said first portion of information; and
allowing said person to provide access to at least two distinct portions of said information to a respective at least two other parties.

30. The method of claim 27, wherein said allowing said person to partition access to said information includes at least one of the following:
allowing said person to grant an ability to at least one other person to access said information;
allowing said person to grant an ability to at least one other person to read said information;
allowing said person to grant an ability to at least one other person to update said information; and
allowing said person to grant an ability to at least one other person to add new information.

31. The method of claim 27, wherein said receiving a request to provide access to a portion of said information to a party includes at least one of the following:
receiving an electronic communication containing said request;
receiving said request from said person; and
receiving said request from said party.

32. The method of claim 27, wherein said providing access to said portion of said information by said party if such access is authorized includes at least one of the following:
allowing said party to retrieve said portion of information;
allowing said party to update said portion of information; and
sending said portion of information to said party.

33. The method of claim 27, further comprising:
providing a notification to said person when access to any portion of said information is granted.

34. The method of claim 27, further comprising:
determining if said party is authorized to access said portion of said information.

35. The method of claim 27, wherein said request includes at least one of the following:
an identifier associated with said person;
an identifier associated with said portion of information;
an identifier associated with said party;
a password that allows access to said portion of information;
a password that allows access to said location; and
a URL.

36. A system for providing information regarding a product, comprising:
a memory;
a communication port; and
a processor connected to said memory and said communication port, said processor being operative to:
determine an address for a location where information regarding a product is available;
provide data indicative of said address to an entity that can provide said product;
receive information regarding a recipient of said product; and
update said information regarding said product based, at least in part, on said information regarding a recipient.

37. A computer program product in a computer readable medium for providing information regarding a product, comprising:
first instructions for identifying an address for a location where information regarding a product is available;
second instructions for sending a notification indicative of said address to an entity that can provide said product;
third instructions for obtaining information regarding a recipient of said product; and
fourth instructions for revising said information regarding said product based, at least in part, on said information regarding a recipient.
